(19) United States
(12) Patent Application Publication
(10) Pub. No.: US 2017/0314109 A1
(43) Pub. Date: Nov. 2, 2017

(54) ADDITIVELY MANUFACTURED HIGH-STRENGTH ALUMINUM VIA POWDER BED LASER PROCESSES

(71) Applicant: Northrop Grumman Systems Corporation, Falls Church, VA (US)

(72) Inventor: Alex McCloskey, Venice, CA (US)

(21) Appl. No.: 15/180,713

(22) Filed: Jun. 13, 2016

Related U.S. Application Data
(60) Provisional application No. 62/175,502, filed on Jun. 15, 2015.
(60) Provisional application No. 62/175,760, filed on Jun. 15, 2015.

(51) Int. Cl. C22F 1/04; B33Y 80/00; B23K 26/00; B33Y 10/00; B22F 1/00; B23K 26/342; B33Y 70/00; C21D 1/60; B23K 103/10

(52) U.S. Cl. CPC C22F 1/04; B33Y 70/00; B33Y 80/00; B23K 26/0006; C21D 1/60; B33Y 10/00; B22F 1/0003; B23K 26/342; B22F 2304/10; B23K 2203/10; B22F 2301/052

(57) ABSTRACT

A method for manufacturing a high-strength aluminum includes: receiving atomized aluminum powder having one or more of an approximate desired powder size and an approximate morphology; and sintering the powder. A method for manufacturing a high-strength aluminum includes: receiving atomized aluminum powder having one or more of an approximate desired powder size and an approximate morphology; sintering the powder, producing additively manufactured aluminum; solution heat treating the additively manufactured aluminum; quenching the additively manufactured aluminum; and aging the additively manufactured aluminum. A method for manufacturing a high-strength aluminum includes: receiving atomized aluminum powder having one or more of an approximate desired powder size and an approximate morphology; sintering the powder, producing additively manufactured aluminum; placing the additively manufactured aluminum under one or more of heat treatment and pressure using a hot isostatic press (HIP); and aging the additively manufactured aluminum powder.

### PRIORITY CLAIM

The present application claims the priority benefit of U.S. provisional patent application No. 62/175,502 filed Jun. 15, 2015, entitled “Additively Manufactured, Three-Dimensionally Printed, High-Strength Aluminum Via Power Bed Laser Processes,” and U.S. provisional patent application No. 62/175,760 filed Jun. 15, 2015, and entitled “Additively Manufactured, Three-Dimensionally Printed, High-Strength Aluminum Via Power Bed Laser Processes,” the disclosures of which are incorporated herein by reference.

### SUMMARY

A method for manufacturing a high-strength aluminum includes: receiving atomized aluminum powder having one or more of an approximate desired powder size and an approximate morphology; and sintering the powder.

A method for manufacturing a high-strength aluminum includes: receiving atomized aluminum powder having one or more of an approximate desired powder size and an approximate morphology; sintering the powder, producing additively manufactured aluminum; solution heat treating the powder; quenching the powder; and aging the powder.

A method for manufacturing a high-strength aluminum includes: receiving atomized aluminum powder having one or more of an approximate desired powder size and an approximate morphology; sintering the powder, producing additively manufactured aluminum; placing the additively manufactured aluminum under one or more of heat treatment and pressure using a hot isostatic press (HIP); and aging the additively manufactured aluminum powder.

### DESCRIPTION OF THE DRAWINGS

The accompanying drawings provide visual representations which will be used to more fully describe various representative embodiments and can be used by those skilled in the art to better understand the representative embodiments disclosed herein and their advantages. In these drawings, like reference numerals identify corresponding elements.

FIGS. 1A-1D are a set of four images at a resolution of 30 micrometers (30 μm) and at four different magnification levels, of an additively manufactured high-strength aluminum made using powder bed laser processes.

FIG. 2 is a graph of hardness vs. aging time for a typical prior art and for an additively manufactured high-strength aluminum made using powder bed laser processes.

FIGS. 3A-3C are a set of three graphs of ultimate tensile strength, tensile yield strength, and ductility for four prior arts and for an additively manufactured high-strength aluminum made using powder bed laser processes.

FIG. 4 is a flowchart of a method for manufacturing a high-strength aluminum.

FIG. 5 is a flowchart of a method for manufacturing a high-strength aluminum.

FIG. 6 is a flowchart of a method for manufacturing a high-strength aluminum.

### DETAILED DESCRIPTION

While the present invention is susceptible of embodiment in many different forms, there is shown in the drawings and will herein be described in detail one or more specific embodiments, with the understanding that the present disclosure is to be considered as exemplary of the principles of the invention and not intended to limit the invention to the specific embodiments shown and described. In the following description and in the several figures of the drawings, like reference numerals are used to describe the same, similar or corresponding parts in the several views of the drawings.

According to embodiments of the invention, a method is provided for manufacturing a high-strength aluminum via additive manufacturing. According to further embodiments of the invention, a method is provided for manufacturing the high-strength aluminum via three-dimensional (3D) printing. According to other embodiments of the invention, the method for manufacturing comprises additively manufacturing the high-strength aluminum from an aluminum alloy. According to yet other embodiments of the invention, the aluminum alloy comprises AMS 4471 (http://standards.sae.org/ams4471). AMS 4471 is marketed as A2OX (www.aeromet.co.uk/a20x/index.html), and is available from Aeromet International PLC (www.aeromet.co.uk) of Sittingbourne, Kent, United Kingdom.

Embodiments of the invention provide yield strengths up to approximately 52 thousand pounds per square inch (ksi). By contrast, prior art additively manufactured aluminum-silicon-based alloys have yield strengths up to approximately 27-35 ksi, and prior art wrought alloys have yield strengths between approximately 40 ksi and approximately 70 ksi.

According to still further embodiments of the invention, the method for manufacturing comprises receiving aluminum that has been atomized to one or more of an approximate desired powder size and an approximate morphology. According to yet further embodiments of the invention, the powder size is at least approximately ten micrometers (10 μm). According to other embodiments of the invention, the powder size is less than or equal to approximately fifty micrometers (50 μm).

According to embodiments of the invention, the powder layer thickness is at least approximately twenty micrometers (20 μm). According to other embodiments of the invention, the powder layer thickness is less than or equal to approximately fifty micrometers (50 μm).

According to embodiments of the invention, the bead width is at least approximately fifty micrometers (50 μm). According to other embodiments of the invention, the bead width is less than or equal to approximately 500 micrometers (500 μm).

According to embodiments of the invention, the method for manufacturing comprises sintering the powder. According to further embodiments of the invention, the method for manufacturing comprises sintering the powder via 3D printing. According to yet further embodiments of the invention, the method for manufacturing comprises sintering the powder via 3D printing and according to one or more specific parameters.

According to embodiments of the invention, the method for manufacturing comprises selective laser melting (SLM), also known as powder bed laser additive manufacturing, also known as direct laser metal sintering (DLMS). According to other embodiments of the invention, the method for manufacturing comprises another type of 3D printing other than SLM.

According to still further embodiments of the invention, the method for manufacturing comprises applying power at a level of at least approximately 200 watts. According to yet other embodiments of the invention, the method for manufacturing comprises applying power at a level of less than or equal to approximately 600 watts.

According to yet other embodiments of the invention, the method for manufacturing comprises moving the powder source at a speed of at least approximately 150 millimeters per second. According to further embodiments of the invention, the method for manufacturing comprises moving the power source at a speed of les than approximately 1,300 millimeters per second.

According to still other embodiments of the invention, the method for manufacturing comprises one or more specific procedures for post-processing the aluminum. For example, the method for manufacturing comprises one or more specific procedures for post-processing the aluminum to achieve one or more of a desired approximate strength, a desired approximate ductility, and a desired approximate density. For example, the desired approximate ductility comprises an elongation of approximately 12%. For example, the desired approximate density comprises one or more of an as-processed density of greater than approximately 98% and a post-processing density of less than or equal to approximately 100%.

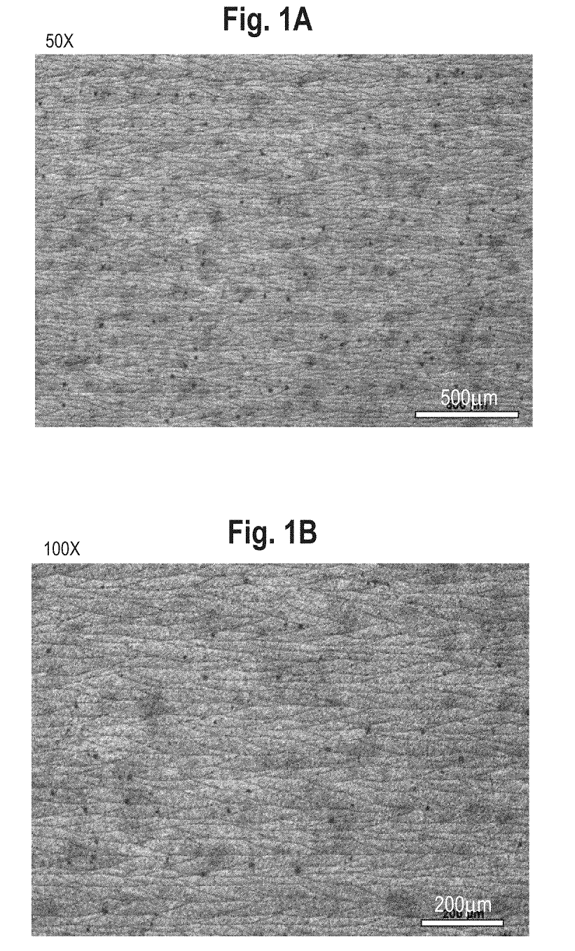

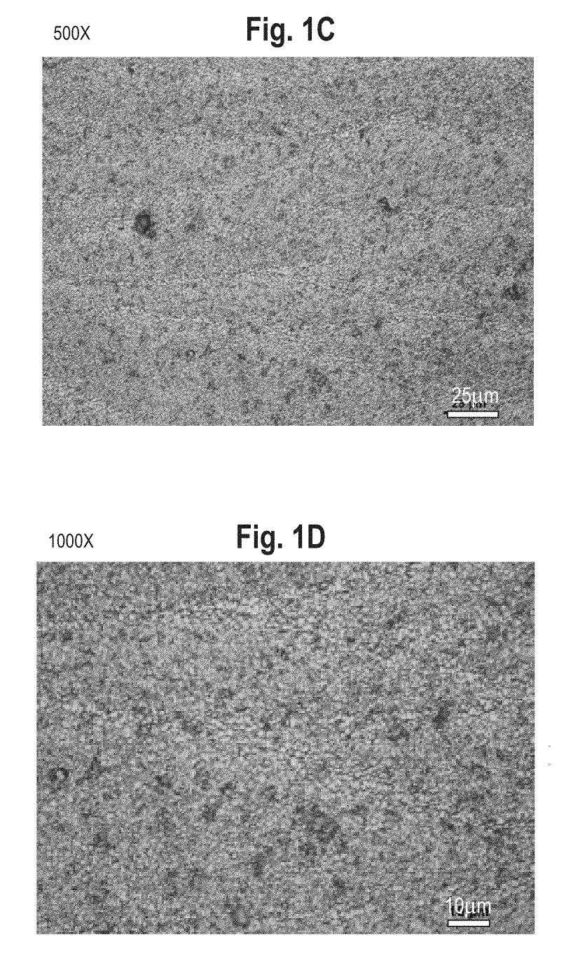

FIGS. 1A-1D are a set of four images at a resolution of 30 micrometers (30 μm) and at respective magnification levels of 50×, 100×, 500×, and 1000×, of an additively manufactured high-strength aluminum made using powder bed laser processes.

As can be seen from FIGS. 1A-1D, following the method for manufacturing according to embodiments of the invention, the integrity and uniformity of the resulting material is excellent, with one or more of a negligible number of voids and no voids. For example, the result material has one or more of an as-processed density of greater than approximately 98% and a post-processing density equal to approximately 100%. Also, the melt pool size, uniformity and shape in this material indicates good material consistency and quality. These beneficial results are shown for material that did not undergo any post-processing thermal treatment or consolidation via a hot isostatic press (HIP).

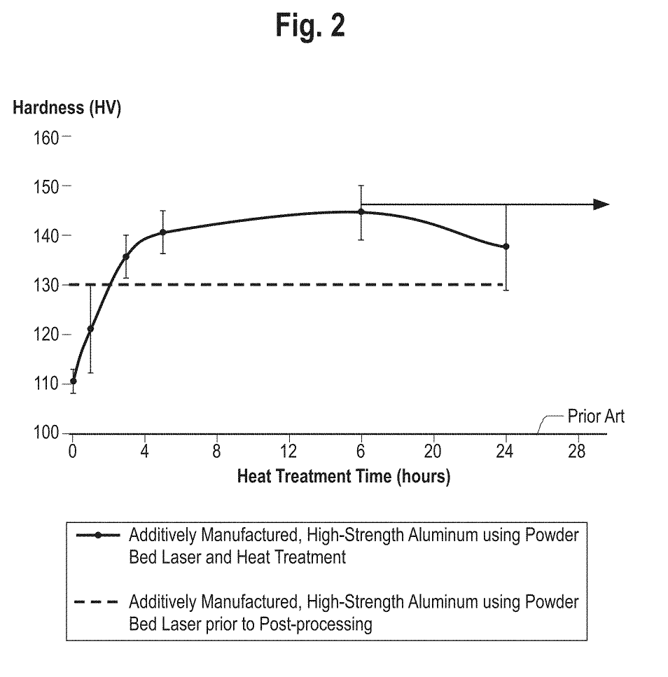

FIG. 2 is a graph for a 170° C. (170 degrees Centigrade) isothermal heat treatment study of hardness (in Vickers Pyramid Number [HV]) vs. heat treatment time (in hours) for a typical A356-T6 prior art, for an additively manufactured high-strength aluminum made using powder bed laser processes prior to post-processing, and for an additively manufactured high-strength aluminum made using powder bed laser processes and heat treatment.

As can be seen from FIG. 2, embodiments of the invention exhibit far superior characteristics to typical A356-T6 as currently used in 3D printing. Embodiments of the invention approach the performance of typical wrought 7050-T74, but do so while being achievable via 3D printing.

According to embodiments of the invention, the method for manufacturing further comprises post-processing. According to further embodiments of the invention, the post-processing comprises heat treatment of the high-strength aluminum after additive manufacturing. According to yet other embodiments of the invention, the post-processing comprises heat treatment of the high-strength aluminum after additive manufacturing using a solution heat treatment. Such solution heat treatment is sometimes called homogenization because it can do one or more of re-dissolve and re-homogenize segregated microstructure of the alloy.

According to further embodiments of the invention, the heat treatment uses a hot isostatic press (HIP). For example, the HIP places the additively manufactured high-strength aluminum under one or more of heat treatment and pressure, thereby performing one or more of closing holes and reducing porosity. For example, the HIP places the powder under a pressure of approximately 105 million pascals (105 MPa), a pressure that is roughly equivalent to approximately 15,000 ksi. For example, the HIP places the powder under a pressure of between approximately 90 MPa and approximately 200 MPa. For example, the HIP places the powder under pressure for a time period of at least approximately two hours. For example, the HIP places the powder under pressure for a time period less than or equal to approximately four hours.

According to embodiments of the invention, the heat treatment comprises heat treatment within a temperature window. For example, the HIP temperature window is bounded by temperatures of approximate 520 degrees Centigrade and approximately 538 degrees Centigrade.

For example, the solution heat treatment also stated as homogenization heat treatment comprises heat treatment within a time window approximately equal to one hour. For example, the heat treatment comprises heat treatment within a time window approximately equal to thirty minutes.

According to still other embodiments of the invention, the method for manufacturing comprises quenching the additively manufactured high-strength aluminum. According to still other embodiments of the invention, the post-processing comprises quenching the additively manufactured high-strength aluminum. For example, the method for manufacturing further comprises quenching the additively manufactured high-strength aluminum. For example, the method for manufacturing further comprises quenching the additively manufactured high-strength aluminum using water. For example, the method for manufacturing further comprises quenching the additively manufactured high-strength aluminum using a quenching medium other than water.

For example, according to yet other embodiments of the invention, the method for manufacturing further comprises aging the resulting additively manufactured high-strength aluminum. For example, according to yet other embodiments of the invention, post-processing further comprises aging the resulting additively manufactured high-strength aluminum. For example, the method for manufacturing further comprises aging the resulting additively manufactured high-strength aluminum at a temperature of approximately 170 degrees Centigrade. For example, the aging comprises aging the resulting additively manufactured high-strength aluminum for a time period of at least approximately nine hours. For example, the aging comprises aging the resulting additively manufactured high-strength aluminum for a time period less than or equal to approximately eleven hours. For example, the resulting aluminum may be categorized as T6.

For example, the method for manufacturing further comprises aging the resulting additively manufactured high-strength aluminum at a temperature of approximately 170 degrees Centigrade. For example, the aging method comprises aging the resulting additively manufactured high-strength aluminum for a time period of at least approximately fourteen hours. For example, the aging method comprises aging the resulting additively manufactured high-strength aluminum for a time period less than or equal to approximately sixteen hours. For example, the resulting aluminum may be categorized as T7.

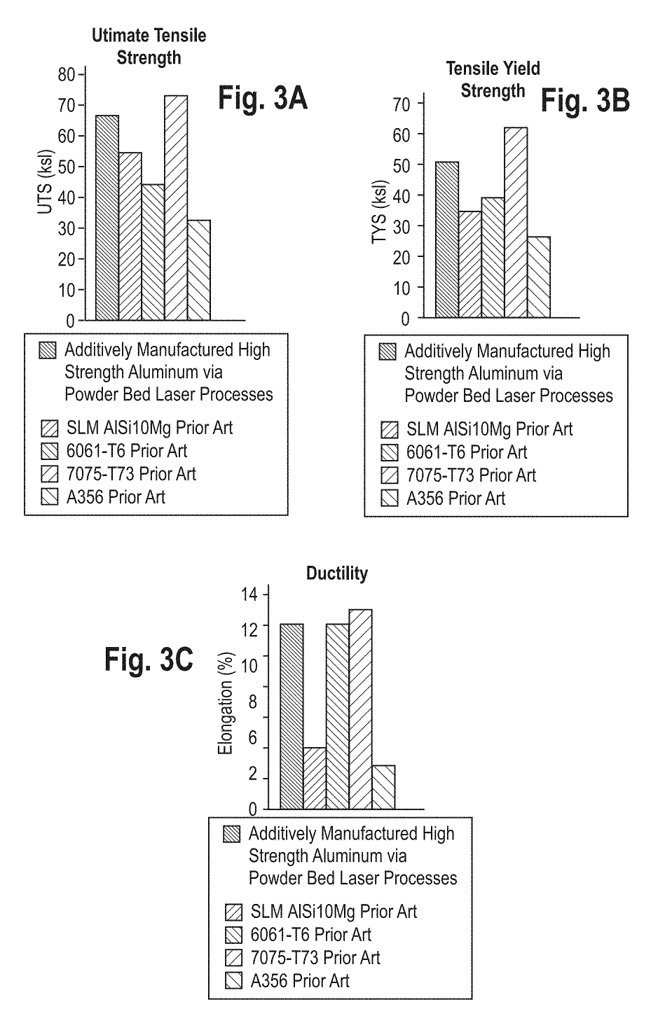

FIGS. 3A-3C are a set of three graphs of typical average values of ultimate tensile strength, tensile yield strength, and ductility for four prior arts and for an additively manufactured high-strength aluminum made using powder bed laser processes.

FIG. 3A is a graph of typical average values of ultimate tensile strength (UTS) in ksi for embodiments of the invention and for four prior arts. The first prior art is the aluminum alloy AlSi10Mg produced via selective laser melting (SLM), an additive manufacturing process.

The other three prior arts illustrated in FIGS. 3A-3C are not produced via additive manufacturing. The second prior art is 6061-T6 aluminum plate. The third prior art is 7075-T73 aluminum plate. The fourth and final prior art is A356 aluminum casting alloy. FIG. 3A shows that embodiments of the invention have a higher UTS than additively manufactured prior art. FIG. 3A also shows that embodiments of the invention have a substantially higher UTS than all depicted prior art apart from 7075-T73.

FIG. 3B is a graph of typical average values of tensile yield strength (TYS) in ksi for embodiments of the invention and for four prior arts. The first prior art is again the aluminum alloy AlSi10Mg produced via SLM. The second prior art is again 6061-T6 aluminum plate. The third prior art is again 7075-T73 aluminum plate. The fourth and final prior art is again A356 aluminum casting alloy. FIG. 3B shows that embodiments of the invention have a substantially higher TYS than additively manufactured prior art. FIG. 3B also shows that embodiments of the invention have a substantially higher UTS than all depicted prior art apart from 7075-T73.

FIG. 3C is a graph of typical average ductility (elongation percentage) for embodiments of the invention and for four prior arts. The first prior art is again the aluminum alloy AlSi10Mg produced via SLM. The second prior art is again 6061-T6 aluminum plate. The third prior art is again 7075-T73 aluminum plate. The fourth and final prior art is again A356 aluminum casting alloy. FIG. 3C shows that embodiments of the invention have a substantially higher ductility than additively manufactured prior art. FIG. 3C also shows that embodiments of the invention have a substantially higher ductility than the A356 aluminum casting alloy, and have a ductility comparable to the 6061-T6 and 7075-T73 prior arts.

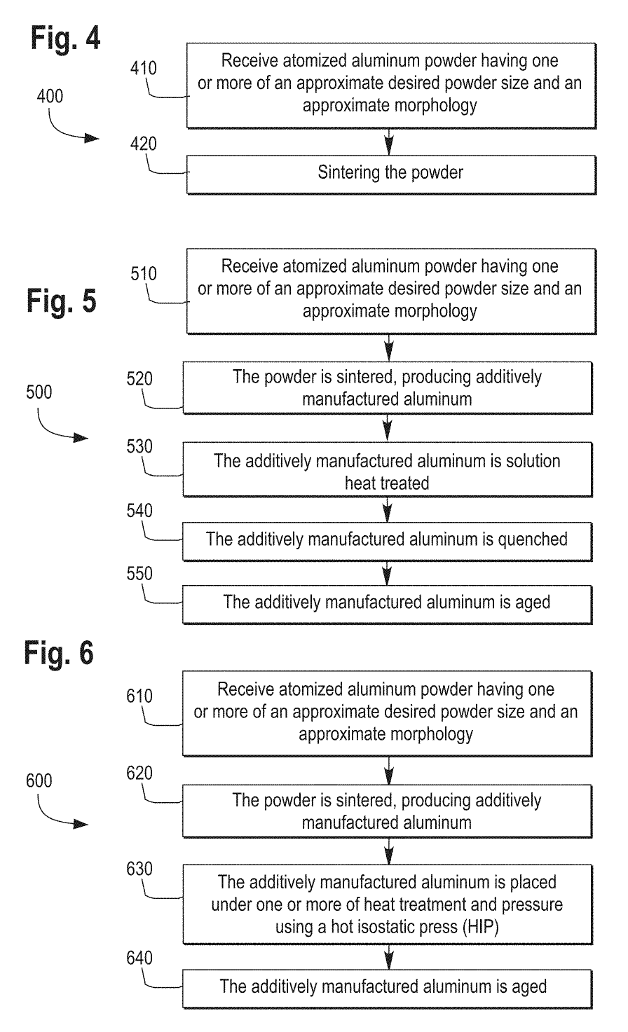

FIG. 4 is a flowchart of a method 400 for manufacturing a high-strength aluminum. The order of steps in the method 400 is not constrained to that shown in FIG. 4 or described in the following discussion. Several of the steps could occur in different order without affecting the final result.

In step 410, atomized aluminum powder is received having one or more of an approximate desired powder size and an approximate morphology. Block 410 then transfers control to block 420.

In step 420, the powder is sintered. Block 420 then terminates this process.

FIG. 5 is a flowchart of a method 500 for manufacturing a high-strength aluminum. The order of steps in the method 500 is not constrained to that shown in FIG. 5 or described in the following discussion. Several of the steps could occur in different order without affecting the final result.

In step 510, atomized aluminum powder is received having one or more of an approximate desired powder size and an approximate morphology. Block 510 then transfers control to block 520.

In step 520, the powder is sintered, producing additively manufactured aluminum. Block 520 then transfers control to block 530.

In step 530, the additively manufactured aluminum is solution heat treated. Block 530 then transfers control to block 540.

In step 540, the additively manufactured aluminum is quenched. Block 540 then transfers control to block 550.

In step 550, the additively manufactured aluminum is aged. Block 550 then terminates this process.

FIG. 6 is a flowchart of a method 600 for manufacturing a high-strength aluminum. The order of steps in the method 600 is not constrained to that shown in FIG. 6 or described in the following discussion. Several of the steps could occur in different order without affecting the final result.

In step 610, atomized aluminum powder is received having one or more of an approximate desired powder size and an approximate morphology. Block 610 then transfers control to block 620.

In step 620, the powder is sintered, producing additively manufactured aluminum. Block 620 then transfers control to block 630.

In step 630, the additively manufactured aluminum is placed under one or more of heat treatment and pressure using a hot isostatic press (HIP). Block 630 then transfers control to block 640.

In step 640, the additively manufactured aluminum is aged. Block 640 then terminates this process.

Embodiments of the invention provide numerous benefits. Prior to embodiments of the current invention, it is believed that no method or aluminum material was known that (a) can be successfully additively manufactured using powder bed processes and (b) rivals 7××× series wrought aluminum in terms of yield strength. A 3D printed high-strength aluminum produced according to embodiments of the invention allows for low-cost, high-complexity parts for a number of industry sectors. According to embodiments of the invention, a 3D printed version of this alloy has been shown to possess improved uniformity of material microstructure as a function of geometry.

Other benefits provided by embodiments of the invention include a significant reduction in solute segregation that is, problems with solute not dissolving. The reduction in copper segregation enables rapid homogenization. The reduction in copper segregation also prevents incipient melting during alloy post-processing. Due to the reduced solute segregation, any solute that has not dissolved into the bulk alloy according to embodiments of the invention will do so after a short time at the elevated temperature. Rapid homogenization means shorter hold times at elevated temperature during heat treatments, which supports retention of the original microstructure responsible for the material's tensile strength.

The rapid homogenization also supports a reduced tendency for hot tearing, allowing for creation of complex designs with relatively uniform properties. This has been verified by example, i.e., by building demonstration parts. Prior art castings have a part geometry that drives a solidification rate and order from the melt, in turn producing a variable grain structure and non-uniform properties. By contrast, embodiments of the invention have relatively uniform properties because the melt zone is very small and the melt pool size is held relatively constant, producing a much more uniform grain structure.

Embodiments of the invention provide tensile yield strengths of approximately 65 ksi and densities of approximately 99%.

The aluminum produced according to embodiments of the invention has a higher strength than any existing additively manufactured aluminum. Prior art aluminum-silicon-based additively manufactured have yield strengths up to approximately 27-35 ksi, and prior art wrought alloys have yield strengths between approximately 40 ksi and approximately 70 ksi, whereas embodiments of the invention provide yield strengths up to approximately 52 ksi.

Relative to aluminum produced using cast processing, aluminum produced according to embodiments of the invention also possesses one or more of improved uniformity in microstructure, improved mechanical performance and improved mechanical properties. The improved uniformity is based on qualitative analysis of the microstructure of embodiments of the invention, using one or more of photomicrographs and scanning electron microscope images. The prior art tends to comprise large elongated grains while embodiments of the invention comprise grains that are equiaxed. The improved mechanical properties refers to a better yield strength. The prior art aerospace castings have a typical yield strength of approximately 27 ksi whereas embodiments of the invention have a typical yield strength of approximately 52 ksi.

Aluminum produced according to embodiments of the invention can also more readily achieve complex geometries compared to prior art castings, which tend to be more limited by geometric variables including section thickness.

The method for manufacturing also results in significantly refined grain sizes. For example, representative grain sizes are less than or equal to approximately 10 micrometers (10 μm), a size that is much finer than that achieved by existing wrought and cast techniques.

Another advantage of embodiments of the invention is that the integrity of the resulting material is excellent, with one or more of a negligible number of voids and no voids. For example, the resulting material has one or more of an as-processed density of greater than approximately 98% and a post-processing density equal to approximately 100%. The beneficial result of an as-processed density of greater than approximately 98% is shown for material that did not undergo any post-processing thermal treatment or consolidation via a hot isostatic press (HIP).

It will be further understood by those of skill in the art that the number of variations of the invention and the like are virtually limitless. It is intended, therefore, that the subject matter in the above description shall be interpreted as illustrative and shall not be interpreted in a limiting sense.

While the above representative embodiments have been described with certain components in exemplary configurations, it will be understood by one of ordinary skill in the art that other representative embodiments can be implemented using different configurations and/or different components. For example, it will be understood by one of ordinary skill in the art that the order of certain steps and certain components can be altered without substantially impairing the functioning of the invention.

The representative embodiments and disclosed subject matter, which have been described in detail herein, have been presented by way of example and illustration and not by way of limitation. It will be understood by those skilled in the art that various changes may be made in the form and details of the described embodiments resulting in equivalent embodiments that remain within the scope of the invention. It is intended, therefore, that the subject matter in the above description shall be interpreted as illustrative and shall not be interpreted in a limiting sense.

We claim:

1. A method for manufacturing a high-strength aluminum; comprising:
receiving atomized aluminum powder having one or more of an approximate desired powder size and an approximate morphology; and
sintering the powder.

2. The method of claim 1, wherein the step of receiving comprises receiving an atomized aluminum alloy composite.

3. The method of claim 1, wherein the step of receiving comprises receiving powder having a powder size of at least approximately ten micrometers (10 μm) and less than or equal to approximately fifty micrometers (50 μm).

4. The method of claim 1, wherein the step of receiving comprises receiving powder having a powder layer thickness of at least approximately twenty micrometers (20 μm) and less than or equal to approximately fifty micrometers (50 μm).

5. The method of claim 1, wherein the step of receiving comprises receiving powder having a bead width of at least approximately fifty micrometers (50 μm) and less than or equal to approximately 500 micrometers (500 μm).

6. The method of claim 1, wherein the step of sintering is performed via three-dimensional (3D) printing.

7. The method of claim 6, wherein the step of sintering is performed via selective laser melting (SLM).

8. The method of claim 1, further comprising a step, performed after the sintering step, of:
post-processing the aluminum.

9. The method of claim 8, wherein the post-processing step comprises placing the additively manufactured aluminum under one or more of heat treatment and pressure.

10. The method of claim 9, wherein the heat treatment comprises solution heat treatment.

11. The method of claim 10, wherein the solution heat treatment comprises quenching the additively manufactured aluminum.

12. The method of claim 11, wherein the quenching step comprises quenching the additively manufactured aluminum using water.

13. The method of claim 8, wherein the post-processing step comprises placing the additively manufactured aluminum under one or more of heat treatment and pressure using a hot isostatic press (HIP).

14. The method of claim 13, wherein the post-processing step comprises placing the additively manufactured aluminum under a pressure of approximately 105 million pascals (105 Mpa), for a time period of at least approximately two hours and a time period less than or equal to approximately four hours.

15. The method of claim 10, wherein the post-processing step comprises heat treatment within a temperature window.

16. The method of claim 15, wherein the heat treatment comprises heat treatment within a temperature window bounded by temperatures of approximate 520 degrees Centigrade and approximately 538 degrees Centigrade.

17. The method of claim 15, wherein the heat treatment comprises heat treatment within a time window equal to between approximately thirty minutes and approximately one hour.

18. The method of claim 8, wherein the post-processing step comprises aging the additively manufactured aluminum.

19. The method of claim 18, wherein the aging comprises aging the resulting additively manufactured aluminum at a temperature of approximately 170 degrees Centigrade.

20. The method of claim 18, wherein the aging comprises aging the additively manufactured aluminum for a time period of at least approximately nine hours and less than or equal to approximately sixteen hours.

21. A method for manufacturing a high-strength aluminum; comprising:
receiving atomized aluminum powder having one or more of an approximate desired powder size and an approximate morphology;
sintering the powder, producing additively manufactured aluminum;
solution heat treating the additively manufactured aluminum;
quenching the additively manufactured aluminum; and
aging the additively manufactured aluminum powder.

22. A method for manufacturing a high-strength aluminum; comprising:
receiving atomized aluminum powder having one or more of an approximate desired powder size and an approximate morphology;
sintering the powder, producing additively manufactured aluminum;
placing the additively manufactured aluminum under one or more of heat treatment and pressure using a hot isostatic press (HIP); and
aging the additively manufactured aluminum powder.
